(19) United States
(12) Patent Application Publication
(10) Pub. No.: US 2025/0342531 A1
(43) Pub. Date: Nov. 6, 2025

(54) Systems and Methods for Facilitating Cross-Border Payments with Matching Transaction Conversion into Domestic Transactions

(71) Applicant: MohammadNader Makarachi, Vaughan (CA)

(72) Inventor: MohammadNader Makarachi, Vaughan (CA)

(21) Appl. No.: 18/973,970

(22) Filed: Dec. 9, 2024

Related U.S. Application Data
(60) Provisional application No. 63/610,319, filed on Dec. 14, 2023.

(51) Int. Cl. G06Q 20/22; G06Q 40/02; G06Q 40/04

(52) U.S. Cl. CPC G06Q 20/223; G06Q 40/023; G06Q 40/024; G06Q 40/053

(57) ABSTRACT

A system and method for facilitating cross-border financial transactions through a money movement transaction marketplace. The system allows users to trade cross-border transaction requests, matching complementary payment needs to enable conversion into domestic equivalents. It includes a matching engine for identifying transaction pairs, a conversion module for domestic settlement, and a compliance framework supporting Anti-Money Laundering (AML) and Know Your Customer (KYC) protocols. The marketplace reduces costs by enabling peer-to-peer trading of transactions, bypassing intermediaries and standard currency conversion processes. The system supports dynamic exchange rate determination, multi-currency operations, and integration with financial institutions via standardized Software System's Interfaces (e.g., APIs). Secure communication, encrypted data handling, and fraud detection mechanisms ensure compliance and reliability. By addressing inefficiencies in traditional cross-border systems, the invention promotes financial inclusion and aligns with global goals to provide accessible, cost-effective solutions for underserved populations while ensuring transparency and scalability in cross-border payments.

### CROSS-REFERENCE TO RELATED APPLICATIONS

This application claims the benefit of U.S. Provisional Patent Application No. 63/610,319, filed on Dec. 14, 2023, under 35 U.S.C. § 119(e).

### FEDERALLY SPONSORED RESEARCH AND DEVELOPMENT

Not Applicable.

### JOINT RESEARCH AGREEMENT

Not Applicable.

### REFERENCE TO A “SEQUENCE LISTING”, A TABLE, OR A COMPUTER PROGRAM LISTING APPENDIX SUBMITTTED ON A COMPACT DISC AND AN INCORPORATION-BY-REFERENCE OF THE MATERIAL ON THE COMPACT DISC

Not Applicable.

### PRIOR ART

Not Applicable.

### BACKGROUND OF THE INVENTION

Global cross-border money transfers often remain expensive and inefficient, primarily due to traditional systems relying on intermediaries such as banks and fintech platforms. These intermediaries incur high fees, delayed transaction times, and unfavorable exchange rates for consumers. Recognizing these challenges, our innovation introduces a peer-to-peer marketplace for cross-border transfers, bypassing intermediaries and enabling users to transact directly. This approach promotes faster, more cost-effective transactions and allows users to set fair exchange rates, creating substantial savings.

Moreover, this solution supports the United Nations Sustainable Development Goals (SDGs), particularly Goal 10, which seeks to reduce inequality within and among countries. By streamlining international remittances and lowering transaction costs to below the 3% target outlined by the SDGs, the innovation advances global financial inclusion. It enables individuals in underserved regions to access efficient, transparent, and secure financial services, ensuring equitable economic participation.

Further, the design ensures full legal compliance, providing users with a secure and trustworthy platform that adheres to international financial regulations. This innovation is not merely a financial tool but a strategic effort to address global disparities in economic connectivity and access to financial systems.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a method for facilitating cross-border payments with matching transaction conversion into domestic transactions is disclosed. Further, the method may include a step of receiving, using a communication device, at least one first currency transfer request from at least one first account holder device associated with at least one first account holder for converting a monetary value by exchanging at least one first currency of at least one first country for at least one second currency of at least one second country. Further, the method may include a step of retrieving, using a storage device, a plurality of pending currency transfer request information associated with a plurality of pending currency transfer requests from a plurality of registered account holders. Further, the method may include a step of analyzing, using a processing device, the at least one first currency transfer request and the plurality of pending currency transfer request information. Further, the method may include a step of identifying, using the processing device, at least one second currency transfer request associated with at least one second account holder of the plurality of registered account holders for converting at least a part of the monetary value by exchanging the at least one second currency for the at least one first currency based on the analyzing. Further, the method may include a step of generating, using the processing device, at least one notification indicating at least one mutual connection between the at least one first account holder and the at least one second account holder based on the identifying. Further, the method may include a step of transmitting, using the communication device, the at least one notification to the at least one first account holder device and at least one second account holder device associated with the at least one second account holder. Further, the method may include a step of receiving, using the communication device, at least one first transaction confirmation from the at least one first account holder device and at least one second transaction confirmation from the at least one second account holder device based on the at least one notification. Further, the method may include a step of assigning, using the processing device, a first currency amount equitable to at least a part of the monetary value in the at least one first currency to at least one second recipient wallet of at least one second recipient of the at least one second account holder and a second currency amount equitable to the first currency amount in the at least one second currency to at least one first recipient wallet of the at least one first recipient of the at least one first account holder based on the at least one first transaction confirmation and the at least one second transaction confirmation. Further, the method may include a step of processing, using the processing device, at least one transaction for an exchange of the at least one first currency and the at least one second currency equitable to at least a part of the monetary value between at least one first account of the at least one first account holder and at least one second account of the at least one second account holder based on the at least one first transaction confirmation and the at least one second transaction confirmation. Further, the method may include a step of generating, using the processing device, at least one confirmation notification indicating transaction completion of the at least one transaction. Further, the method may include a step of transmitting, using the communication device, the at least one confirmation notification to the at least one first account holder device and the at least one second account holder device.

According to some aspects, a system for facilitating cross-border payments with matching transaction conversion into domestic transactions is disclosed. Accordingly, the system may include a processing device, a communication device, and a storage device. Further, the communication device may be communicatively coupled with the processing device. Further, the communication device may be communicatively coupled with the storage device. Further, the storage device may be communicatively coupled with the processing device. Further, the communication device may be configured for receiving at least one first currency transfer request from at least one first account holder device associated with at least one first account holder for converting a monetary value by exchanging at least one first currency of at least one first country for at least one second currency of at least one second country. Further, the communication device may be configured for transmitting at least one notification to the at least one first account holder device and at least one second account holder device associated with the at least one second account holder. Further, the communication device may be configured for receiving at least one first transaction confirmation from the at least one first account holder device and at least one second transaction confirmation from the at least one second account holder device based on the at least one notification. Further, the communication device may be configured for transmitting at least one confirmation notification to the at least one first account holder device and the at least one second account holder device. Further, the processing device may be configured for analyzing the at least one first currency transfer request and a plurality of pending currency transfer request information. Further, the processing device may be configured for identifying at least one second currency transfer request associated with at least one second account holder of a plurality of registered account holders for converting at least a part of the monetary value by exchanging the at least one second currency for the at least one first currency based on the analyzing. Further, the processing device may be configured for generating the at least one notification indicating at least one mutual connection between the at least one first account holder and the at least one second account holder based on the identifying. Further, the processing device may be configured for assigning a first currency amount equitable to at least a part of the monetary value in the at least one first currency to at least one second recipient wallet of at least one second recipient of the at least one second account holder and a second currency amount equitable to the first currency amount in the at least one second currency to at least one first recipient wallet of the at least one first recipient of the at least one first account holder based on the at least one first transaction confirmation and the at least one second transaction confirmation. Further, the at least one first recipient may be associated with the at least one second country and the at least one second recipient may be associated with the at least one first country. Further, the processing device may be configured for processing at least one transaction for an exchange of the at least one first currency and the at least one second currency equitable to at least a part of the monetary value between at least one first account of the at least one first account holder and at least one second account of the at least one second account holder based on the assigning. Further, the processing device may be configured for generating the at least one confirmation notification indicating transaction completion of the at least one transaction. Further, the storage device may be configured for retrieving a plurality of pending currency transfer request information associated with the plurality of pending currency transfer requests from the plurality of registered account holders.

Both the foregoing summary and the following detailed description provide examples and are explanatory only. Accordingly, the foregoing summary and the following detailed description should not be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flowchart of a method for facilitating cross-border payments with matching transaction conversion into domestic transactions, in accordance with some embodiments.

FIG. 3 is a continuation of the flowchart described in FIG. 2, in accordance with some embodiments.

FIG. 4 is a block diagram of a system for facilitating cross-border payments with matching transaction conversion into domestic transactions, in accordance with some embodiments.

FIG. 5 is a flowchart of a method for facilitating cross-border payments with matching transaction conversion into domestic transactions, in accordance with some embodiments.

FIG. 6 is a flow diagram of a system facilitating cross-border payments with matching transaction conversion into domestic transactions, in accordance with some embodiments.

FIG. 7 is a flow diagram of a system facilitating cross-border payments with matching transaction conversion into domestic transactions, in accordance with some embodiments.

FIG. 8 is a flow diagram of a system facilitating cross-border payments with matching transaction conversion into domestic transactions, in accordance with some embodiments.

FIG. 9 is a block diagram of a computing device for implementing the methods disclosed herein, in accordance with some embodiment

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any dictionary definition of such term, it is intended that the meaning of the term as understood by the ordinary artisan should prevail.

Furthermore, it is important to note that, as used herein, “a” and “an” each generally denotes “at least one” but do not exclude a plurality unless the contextual use dictates otherwise. When used herein to join a list of items, “or” denotes “at least one of the items” but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. These headers are used as references and are not to be construed as limiting upon the subjected matter disclosed under the header.

The present disclosure includes many aspects and features. Moreover, while many aspects and features relate to, and are described in the context of systems and methods for facilitating cross-border payments with matching transaction conversion into domestic transactions, embodiments of the present disclosure are not limited to use only in this context.

The present disclosure describes systems and methods for facilitating cross-border payments with matching transaction conversion into domestic transactions. system relates to payment processing systems, with a particular focus on cross-border fund transfers. Specifically, the system presents an approach to streamline international monetary exchanges by identifying and pairing corresponding international transactions and subsequently processing them as domestic transfers. This method obviates the need for adherence to international banking regulations and sidesteps reliance on conventional banking channels and payment networks, such as SWIFT and SEPA. To clarify the system's operative mechanism, consider a transaction between Country C1 and Country C2:

Within Country C1: Initiator (Sender) A1 intends to transfer an amount (e.g., $1,000 USD) to beneficiary (recipient) A2 in Country C2, which uses the Euro. Using the current exchange rate of 1 Euro=1.12 USD, A2 is set to receive 892.86 Euro.

Within Country C2: Initiator (Sender) B1 plans to send $1,000 USD to beneficiary (Recipient) B2 in Country C1. Based on the current exchange rate of 1 USD=0.89 Euro, B1 would spend 892.85 Euro to facilitate a $1,000 USD transfer to B2.

Upon identifying these parallel transactions, money is not transferred internationally. Instead, it is deducted from a sender's ledger in one country and added to a receiver's ledger in the same country. The reverse occurs for the other transaction.

For instance, the mentioned payment system deducts $1,000 USD from A1′s ledger in Country C1, where the ledger represents either the user's bank account or their wallet within the system, and credits it to B2′s ledger, similarly represented, in the same country. Simultaneously, 892.86 Euro is taken from B2′s ledger in Country C2 and credited to A2′s ledger in the same country. This dual transfer process ensures localized transactions within each jurisdiction, minimizing the complexities associated with cross-border fund movement while maintaining accurate accounting records in the respective ledgers.

In instances where transaction imbalances arise due to insufficient counterparties or mismatched amounts between countries, the system employs a multifaceted approach to ensure seamless processing. A liquidity pool in each jurisdiction temporarily facilitates unmatched transactions, which are later reconciled as new counterpart transactions become available. For immediate user needs, the system supports partial matching, allowing users to fulfill part of their transaction while queuing the remainder. Dynamic exchange rate adjustments incentivize participation in underrepresented regions, and integration with external financial networks ensures fallback solutions for persistent imbalances. Users are provided with real-time updates and options to customize their transaction preferences, ensuring transparency and control.

Beneficiaries A2 and B2 can move funds from their system ledgers to traditional bank accounts using integrated banking Software System's Interfaces (e.g., APIs) or by consulting an MSB (Money Service Bureau) representative.

To prevent liquidity issues in the mentioned system—for instance, if many users don't promptly move their ledger balances to bank accounts—a periodic settlement mechanism with the local banking system or short-term investments is employed.

The invented system has a clear fee structure. Though it saves users international transfer costs, it is vital to detail any domestic transaction fees, particularly if banking Software System's Interfaces (e.g., APIs) or MSB agents are used.

To counter frequent currency rate fluctuations, a module manages minor discrepancies due to rate changes that may occur during transaction matching.

The initial Currency Expansion Strategy focuses on major currencies like USD, CAD, INR, Pound Sterling, etc. Subsequent phases will support less traded currencies or those with strict controls.

Potential users might harbor trust issues. A detailed strategy for market education and building credibility has been established.

Moreover, the system ensures domestic transfers align with local regulations, and needed currency conversions, and fully comply with the regulatory requirements (including AML and fraud prevention) of each involved nation. Potential partnerships with banks, payment intermediaries, and other relevant entities are explored to ensure smooth money transfers within countries.

To safeguard the system's integrity, multiple validation processes have been integrated. These include authentication/authorization, transaction verification, AML & anti-fraud steps, and encryption measures for data protection. This entails encrypting data in transit and data at-rest, secure data storage, field-level encryption, and routine security evaluations.

The payment system disclosed here operates as follows:

Registration on System—The patent encompasses a comprehensive registration process on the payment system, allowing users to create accounts, provide necessary information, and establish their identities for secure and authorized access to the platform. KYC and customer verification is remotely possible based on each country's regulatory requirements.

Top Up Account—Within the payment system, users have the flexibility to increase their account balances through multiple methods, ensuring convenient access to funds for seamless money transfers. One such method is the ability to top up accounts using widely accepted payment cards, such as Visa cards, Mastercard, and other popular card networks including PayPal, Apple Pay, Alipay, banking Software System's Interfaces (e.g., APIs), etc. Users can securely link their cards to their accounts and initiate top-up transactions, allowing them to transfer money with ease. Additionally, the payment system may offer alternative methods for topping up accounts, such as bank transfers, electronic wallets, or other supported payment options. By providing a range of top-up methods, including card-based options, the payment system accommodates diverse user preferences and enhances the convenience and accessibility of fund transfers.

Demand (create or find a transfer bid)—Within the payment system, users who intend to transfer money have the option to create transaction bids (Transfer Demands or transfer bid), indicating their desired exchange of funds. Prior to creating a request, users must ensure that their account balances have been increased through the top-up methods available in the system.

When creating a transfer bid, the system displays the current exchange rate based on market rates. However, users also have the flexibility to apply their preferred exchange rate, allowing them to tailor the transaction according to their needs. To ensure timely execution, each request is assigned a specific expiration time, such as two hours. If the transaction is not completed within the designated time, the request is automatically canceled and removed from the system

Furthermore, the payment system provides users with access to a list of previous transfer bids (list of active (live) money transfer bids created by other users and available for pick-up with the sender). Users can review this list and, if they find bids that match their needs, they can confirm (accept) those bids (accept to fulfill the bid) directly within the system, eliminating the need to register a new bid. This feature streamlines the process for users, enabling them to quickly identify and confirm compatible transfer bids, enhancing efficiency and user experience within the payment system.

Offer—The payment system provides users with a comprehensive list of transfer bids and suggestions, enabling them to filter and search for the best options based on their specific requirements. Within this list, users can utilize filtering tools to narrow down the results and find the most suitable suggestions and requests.

Each entry in the list specifies the tradable currency of the first party, the corresponding currency of the second party, and the applicable exchange rate. Additionally, the system indicates the remaining time for accepting each request, ensuring transparency and timely decision-making.

Users have the freedom to review the available requests and suggestions, conduct further evaluations, and perform any necessary checks to ensure the authenticity and reliability of the parties involved. Once satisfied, users can accept to fulfill the selected bid, indicating their agreement to proceed with the transaction. By presenting users with a comprehensive list of options and equipping them with filtering tools, the payment system enhances convenience and empowers users to make informed decisions that best suit their needs.

In some embodiments, the system allows users to generate a transfer bid without requiring a sufficient balance in their account or wallet at the time of bid creation. A user may initiate and submit a bid specifying the desired transfer amount and terms, which is subsequently made available for acceptance by potential counterparties in other countries. Upon acceptance of the bid by a counterparty, the system notifies both parties and prompts the initiating user or accepting party or both parties to top-up their account or wallet to the specified amount required to execute the transaction.

If either party fails to fulfill their obligations—such as the initiating user failing to top-up their account or wallet within the system-specified time frame, or the accepting party failing to proceed with the transaction as agreed—the system may impose a penalty on the defaulting party. Additionally, in the event of a bid cancellation by either party after acceptance, the cancelling party may be subject to a cancellation fee to compensate for operational costs and potential disruptions. If both parties fail to fulfill their respective obligations, the system may impose penalties and fees on both parties, ensuring marketplace integrity, deterring misuse, and encouraging commitment to the agreed transaction terms.

Chat module—The payment system incorporates a chat module that facilitates direct communication between bid-generator and bid-acceptor, enabling them to engage in conversations related to currency prices and exchange rates. This module provides a platform for users to interact, share information, and negotiate to reach mutually agreeable terms through bargaining.

By incorporating the chat module, the payment system provides parties with a comprehensive platform that combines the functionality of secure fund transfers with the flexibility of real-time communication, facilitating informed decision-making and promoting a collaborative environment for successful transactions.

Transaction identification and bid fulfillment—Within the payment system, users can identify and accept transaction bids, which are requests for money transfers. When a bid is accepted, the system facilitates the necessary steps to increase the account balance by the specified amount.

Once a demand is accepted, the system prompts the user to provide the recipient's account details. Upon receiving the account information, the payment system prepares the funds by deducting the specified amount from the sender's account and holding it for transfer in the system's intermediary account. Simultaneously, the system verifies the availability of sufficient funds in the sender's account to ensure a successful transaction.

Once the necessary preparations are completed, the payment system initiates the transfer process to the recipient's account. This involves securely processing and transferring the funds from the sender's account to the receiver's account. By streamlining the transfer process and ensuring the availability of funds, the payment system enables efficient and reliable money transfers, enhancing the overall user experience.

Exchange—The payment system incorporates a robust currency conversion feature, enabling users to convert currencies based on the agreed exchange rate. At the core of the system, all exchange rates are referenced against the US dollar (the system base currency is US-Dollar), providing a standardized framework for currency conversions.

When initiating a transaction, users can specify their desired exchange rate, considering the prevailing market conditions and their preferences. The system then utilizes this exchange rate to calculate the corresponding amounts in the respective currencies involved in the transaction.

Alongside the currency conversion process, the payment system charges a fixed transaction fee from the sender for each transaction. This fee is determined upfront and remains constant regardless of the transaction amount. By collecting the fee from the sender, the system ensures a streamlined and transparent approach to covering the costs associated with facilitating the transaction. Fees can be paid by the sender or recipient or split between the parties.

Through the exchange feature, users can conveniently convert currencies based on agreed exchange rates while ensuring clarity and predictability regarding the applicable transaction fees. This enhances user experience and provides a reliable mechanism for currency conversion within the payment system.

GL and Accounting—The payment system incorporates a comprehensive General Ledger (GL) and accounting module that facilitates the creation of multi-product and multi-currency financial accounts for all users. These accounts serve as repositories for recording and tracking the balance, as well as all debits and credits transactions associated with users' financial activities within the system.

Each user is assigned a financial account (known as system wallet) that supports multiple currencies, allowing them to conduct transactions in their preferred currency. The GL and Accounting module ensures accurate and real-time recording of financial transactions, providing users with a transparent overview of their account balances and transaction history.

Furthermore, the system extends its accounting capabilities to include the recording of financial affairs for agents within the system. This feature enables comprehensive tracking and reporting of agents' financial activities, ensuring accountability, and facilitating seamless financial management.

By integrating the GL and Accounting module, the payment system enables users to maintain accurate records, monitor their financial positions, and access detailed transaction histories. This functionality enhances financial transparency, facilitates effective decision-making, and promotes efficient financial management for both users and agents within the system.

Clearing and Settlement—The Clearing and Settlement module is a pivotal component of the payment system, responsible for the secure and efficient settlement of financial accounts. This module plays a crucial role in transforming international transactions into domestic transfers, ensuring seamless fund transfers between the respective senders and recipients.

Within Clearing and Settlement module, the payment system facilitates the movement of funds between users by executing domestic transfers. Specifically, the system collects the funds from sender A1 in country C1 and transfers them to the recipient B2, who is located within the same country, through a domestic transfer mechanism. Simultaneously, the system also transfers the funds from sender B1 in country C2 to the recipient A2 in the same country through another domestic transfer, thereby converting two international transactions into two domestic transactions.

By executing these domestic transfers, the payment system eliminates the complexities and potential challenges associated with international transfers. This approach enhances efficiency, reduces costs, and minimizes the inherent risks involved in cross-border transactions.

The Clearing and Settlement module ensures that funds are securely transferred from the senders to the respective recipients, facilitating smooth financial transactions within the domestic context. By transforming international transactions into domestic transfers, the payment system simplifies the process, strengthens the stability of transactions, and provides users with seamless experience.

Local Financial Regulators—The payment system places great importance on regulatory compliance and recognizes the critical role played by various regulatory bodies. Within this module, the system actively acknowledges and adheres to the laws and regulations established by regulators.

Compliance with regulatory requirements is a top priority for the payment system. It operates within the legal framework defined by regulators to ensure the transparency, security, and integrity of financial transactions. By aligning with regulatory standards, the system aims to build trust and confidence among users and stakeholders, while safeguarding their interests.

The payment system incorporates robust mechanisms to monitor, report, and implement necessary measures for regulatory compliance. These mechanisms include stringent identification and verification procedures, comprehensive transaction monitoring systems, and adherence to industry-specific regulations such as Know Your Customer (KYC) and Anti-Money Laundering (AML) requirements. By actively complying with regulatory guidelines, the system aims to contribute to financial stability, consumer protection, and the prevention of illicit activities.

Transaction Validation and Security—The payment system incorporates technologies to validate transactions and enhance security throughout the platform. Within this module, we employ a range of robust security measures, including One-Time Password (OTP) verification, Open Authentication and authorization ver. 2.0 (OAuth 2.0), Financial-grade APIs (FAPI 2.0), and Identity and Access Management (IAM) protocols, Two-Step Verification, and JSON Web Tokens (OIDC/JWT). Also, encryption/decryption of the date in-transit and data at-rest are in the scopes of this system.

To validate transactions, the system utilizes OTP verification, where a verification code is generated and sent to the user's registered mobile device or email address. The user is required to enter this code to authenticate and authorize the transaction, adding an additional layer of security and preventing unauthorized access.

OAuth 2.0 or FAPI 2.0 and IAM protocols are employed to ensure secure authentication and authorization processes within the system. These protocols facilitate secure access to user accounts and restrict unauthorized access attempts, safeguarding sensitive financial information and preventing fraudulent activities.

Two-Step Verification is implemented to provide an extra layer of security during user authentication. This involves requiring users to provide two independent forms of identification, such as a password and a verification code, before granting access to their accounts.

Also, biometric authentication methods like fingerprints bring the most security while its unlock option allows sender and recipient to verify their identity using biometric feature to protect money transfer in system.

Additionally, the system leverages JSON Web Tokens (JWT) for secure communication and data exchange between different components of the payment system. JWTs encode and digitally sign information, ensuring the integrity and confidentiality of data transmitted across the system.

By incorporating these security measures, the payment system ensures robust transaction validation and safeguards user accounts and sensitive financial data. These measures bolster the overall security posture of the system, providing users with confidence and peace of mind when conducting transactions.

The system Wallet—Subsequently, the deducted funds are deposited into the recipient's wallet within the system. The recipient's wallet serves as a secure digital repository, where the funds are held until further actions are taken, such as withdrawal or transfer to another account.

Throughout the process of fund deduction and depositing into the wallet, the payment system employs security measures to protect the integrity and confidentiality of financial transactions. Encryption protocols, secure communication channels, and authentication mechanisms are utilized to ensure the privacy and security of user data and funds.

Withdrawal—The payment system offers two methods for withdrawals, ensuring flexibility and convenience for the system's account holders. These methods enable the transfer of funds from the system's main account (user wallet) to the user's bank account, either through direct API integration with active banks or via agent-mediated transactions (through MSBs).

In the first method, the payment system establishes collaborations with active banks in the target countries to acquire Application Programming Interfaces (APIs). Through these APIs, funds can be transferred from the intermediary account to the user's bank account seamlessly and in real-time. This process enables fast and efficient withdrawals, ensuring that users can access their funds immediately.

In situations where API integration is not available or feasible, the second method involves utilizing agents to facilitate withdrawals. Agents act as intermediaries between the mentioned payment system and its customers. They withdraw funds from the mentioned system's main account and deposit them into their agent's bank account, and then move the money either to the customer's bank account or pay by cash to the customer on-site. While this method may not offer real-time transfers, it still provides near real-time transactions, allowing users to access their funds quickly and conveniently.

Both withdrawal methods prioritize security and reliability. The payment system employs stringent authentication and authorization protocols to verify the legitimacy of withdrawal requests, protecting customer funds and maintaining the integrity of the transaction process.

Agent (Money Service Bureau) Management—The Agent Management module within the mentioned payment system provides a comprehensive platform for efficiently managing agents and currency throughout various stages. This module enables seamless coordination and oversight of agent activities, ensuring smooth operations and accurate accounting management.

In this module, agents play a crucial role in facilitating transfers and transactions within the system. They act as intermediaries between users, handling currency exchanges and executing settlements on behalf of the users. The module empowers agents with the necessary tools and resources to efficiently manage these activities while maintaining the highest standards of accuracy and security.

The Agent Management module also encompasses revenue management, offering a transparent view of the financial aspects associated with agent operations. It tracks and records revenue generated by agents, providing insights into their performance and contributions. This feature enables effective revenue sharing, ensuring agents are duly compensated for their services while allowing for accurate financial tracking and reporting.

Fee Management—This section relates specifically to the management of fees associated with cross-border transactions.

Cross-border payment systems traditionally involve multiple financial intermediaries, each imposing their own fee structure. These fees can be based on factors like currency conversion, transaction amount, the geographic location of the parties involved, and more. Efficiently managing these fees while ensuring transparency and compliance is a significant challenge.

The present system introduces a fee management system within a cross-border payment processing system. This system automatically calculates, allocates, and discloses fees associated with international transactions, enhancing efficiency, transparency, and regulatory compliance.

### Fee Calculation Engine:

a. Dynamic Rate Identification: The engine retrieves real-time currency conversion rates from trusted financial data sources.
b. Intermediary Fee Integration: It integrates fees charged by participating banks, payment processors, and any other financial intermediaries.
c. Variable Fee Structures: The system supports multiple fee structures, such as flat-rate, percentage-based, or tiered fees, and applies them based on transaction criteria.

### Fee Allocation:

a. Sender/Receiver Fee Allocation: Fees can be allocated wholly to the sender, the receiver, or split between both parties based on predefined rules or user preferences.
b. Intermediary Fee Distribution: Upon processing the payment, the system distributes the collected fees to GL and the accounting system.

### Fee Transparency and Disclosure:

a. Itemized Fee Breakdown: For each transaction, the system provides an itemized breakdown of all fees. This includes conversion fees, service charges, and intermediary fees.
b. Real-time Fee Preview: Before finalizing the transaction, users are presented with a real-time preview of all applicable fees. 3-Historical Fee Access: Users can access a historical record of all fees associated with their transactions.

### Fee Compliance Management:

a. Regulatory Database: The system maintains a dynamic database of fee-related regulations based on country or region. This ensures all fees are compliant with local laws and financial regulations.
b. Automated Reporting: Generates periodic reports detailing fee collections, allocations, and distributions, facilitating regulatory reporting requirements.
   Integration with External Systems:
a. API Integration: The system can integrate with external banking and financial systems to retrieve or push fee-related data.
b. Data Synchronization: Real-time synchronization ensures that fee calculations always use the most recent and accurate data.

Dynamic Matching Algorithms—Implement algorithms that do not just match transactions based on the amount but also consider other variables such as transaction frequency, user behavior, or exchange rate fluctuations.

### Comprehensive Matching Algorithm:

a. Amount Recognition: The core of the system, which identifies transactions primarily based on the transaction amount.
b. Frequency Analysis: Considers the frequency of transactions between two entities to identify patterns and improve match accuracy.

User Behavioral Patterns: Analyzes historical data to discern user-specific transaction behaviors, such as typical transaction times, preferred transaction partners, and commonly used payment methods.

Exchange Rate Analysis: Actively monitors real-time and historical exchange rate fluctuations. If a transaction amount does not match precisely due to minor exchange rate changes, the system recognizes this and accurately matches the transaction.

Adaptive Learning: The system incorporates machine learning algorithms, allowing it to learn and adapt based on previous matching scenarios and outcomes. Over time, it refines its matching accuracy by constantly updating its criteria based on new data.

Fraud Detection Integration: By considering multiple variables, the system enhances its fraud detection capabilities. Anomalous transactions, which deviate significantly from recognized patterns, can be flagged for further review.

User-Centric Customization: Users can provide feedback on transaction matches, allowing the system to further refine its criteria based on individual user preferences and behaviors.

Real-time Feedback Mechanism: If a transaction does not find an immediate match, the system provides real-time feedback, suggesting possible reasons for the mismatch and potential corrective actions.

Priority Transactions: Allow users to flag their transactions as priority, which means their transactions get matched and processed faster, possibly for a premium fee. Traditional cross-border payment systems operate on a first-come, first-served basis, leading to potentially prolonged processing times during peak transaction periods. Given the time-sensitive nature of some transactions, a mechanism to expedite processing becomes essential for users who need immediate transaction matching and conversion. This feature allows users to flag specific transactions as priority, ensuring accelerated matching and processing. While offering enhanced user flexibility, this service may be availed for an additional premium fee.

Traditional cross-border payment systems operate on a first-come, first-served basis, leading to potentially prolonged processing times during peak transaction periods. Given the time-sensitive nature of some transactions, a mechanism to expedite processing becomes essential for users who need immediate transaction matching and conversion.

This feature allows users to flag specific transactions as priority, ensuring accelerated matching and processing. While offering enhanced user flexibility, this service may be availed for an additional premium fee.

### User Interface Enhancements:

a. Priority Flagging Option: Intuitive user interface elements, such as a checkbox or toggle, allow users to designate a transaction as a priority.
b. Fee Disclosure: Prior to confirming the priority status, users are presented with the exact premium fee associated with the expedited service, ensuring complete transparency.

### Backend Processing:

a. Queue Management: Transactions flagged as priority are placed in a dedicated processing queue, ensuring they receive precedence over standard transactions.
b. Dedicated Matching Algorithms: Priority transactions leverage enhanced matching algorithms with increased computational resources, ensuring faster transaction matching and conversion.

### Feedback Mechanism:

a. Real-time Status Updates: Users receive instantaneous notifications regarding the status of their priority transactions, from initiation to completion.
b. Time Estimation: Upon flagging a transaction as priority, users are provided an estimated completion time, giving them clarity on the expedited process.

### Premium Fee Structure:

a. Dynamic Pricing Model: The system incorporates a dynamic pricing model for priority transactions, which may vary based on transaction volume, current system load, or other factors.
b. Flexible Payment Options: Users can opt to pay the premium fee from their existing balance, or through alternative payment methods integrated within the system.
c. Receipt Generation: Upon completion of the priority transaction, users are provided with a detailed receipt, itemizing the standard transaction fee and the additional premium fee for priority processing.

### Security and Compliance:

a. Enhanced Security Protocols: Given the expedited nature of priority transactions, the system deploys heightened security measures to ensure the safety and integrity of the transaction.
b. Regulatory Adherence: The premium fee structure and priority processing mechanism adhere to financial regulations, ensuring compliance in jurisdictions where the system operates.

### Reporting and Analytics:

a. User Dashboard: Users can access a dashboard detailing their historical priority transactions, associated fees, and processing times.
b. System-wide Analytics: The payment system backend continuously monitors and analyzes priority transaction data, facilitating improvements and optimizations based on user behavior and system performance.

Fluctuation Buffer—A reserve system where a small percentage of funds are held to buffer against exchange rate fluctuations during the transaction matching and processing period.
a. Cross-border transactions inherently face the risk of exchange rate fluctuations. Even slight changes in exchange rates between the initiation and finalization of a transaction can result in financial discrepancies. There is a pressing need for a mechanism that ensures transactional accuracy and protects both users and payment processors from unforeseen financial variances.
b. The present system introduces the ‘Fluctuation Buffer’, a reserve system embedded within a cross-border payment platform. This system temporarily holds a minor percentage of transaction funds to counteract potential exchange rate variations during the transaction matching and processing timeframe.
c. Buffer Initialization:
   i. Percentage Determination: An algorithm determines the buffer percentage based on historical exchange rate volatility, the involved currencies, and the transaction amount.
   ii. User Consent: Before initiating the transaction, users are informed about the buffer percentage and its purpose, ensuring transparency and consent.
d. Dynamic Adjustment:
   i. Real-time Monitoring: The system continuously monitors exchange rates during the transaction processing period.
   ii. Buffer Adjustment: Should significant rate fluctuations be detected, the buffer percentage can be dynamically adjusted to ensure adequate coverage, with user notification.
e. Transaction Completion:
   i. Deficit Coverage: If the exchange rate fluctuation results in a deficit, funds from the buffer are used to cover the discrepancy.
   ii. Surplus Redistribution: In cases where fluctuations are favorable, and a surplus remains in the buffer, the excess is returned to the user or can be applied to subsequent transactions, based on user preferences.
f. User Interface and Notifications:
   i. Buffer Dashboard: Users have access to a dedicated dashboard showing buffer amounts, historical fluctuations, and the status of any funds held.
   ii. Real-time Alerts: Notifications alert users to significant exchange rate shifts and any subsequent buffer adjustments.
g. Safety and Compliance:
   i. Regulated Holding: Buffer funds are held in regulated financial environments, ensuring their safety and availability.
   ii. Adherence to Financial Standards: The Fluctuation Buffer system complies with international financial regulations, guaranteeing both user protection and regulatory conformity.
h. Reporting and Analytics:
   i. Detailed Reports: Users can access comprehensive reports on their buffer usage, showcasing the efficacy and benefits of the system in countering rate fluctuations.
   ii. System Analytics: Backend analytics aid in refining the buffer percentage algorithm, ensuring optimal fund withholding and user benefit.

User Profiles and Trust Ratings—Implement user profiles where users can accumulate trust scores based on their transaction history, feedback from other users, or verifications. Higher trust scores could lead to quicker transaction processing or reduced fees. Emphasizing a user-centric approach in cross-border transactions by integrating user profiles with trust ratings, impacting transaction processing times and associated fees.
a. Traditional cross-border payment systems treat transactions in a largely impersonal manner, without accounting for the credibility or trustworthiness of the user. Incorporating a trust system can enhance transaction efficiency, benefit trustworthy users, and reduce potential risks for payment processors.
b. The present system introduces “Profiles and Trust Ratings”, where users have profiles that accumulate trust scores. These scores, based on various factors like transaction history and peer feedback, directly influence transaction processing efficiencies and fee structures.
c. User Profile Initialization:
   i. Registration and Data Collection: Upon registration, users provide necessary details, creating a personalized profile. This profile captures essential transactional information, verifications, and user interactions.
   ii. Initial Trust Score Assignment: New users are assigned an initial trust score, possibly based on their provided verifications or affiliations.
d. Trust Score Accumulation:
   i. Transactional History: Positive transaction outcomes, without disputes or issues, incrementally increase the user's trust score.
   ii. Peer Feedback: After successful transactions, users can rate or review their counterparts, positively impacting trust scores.
   iii. Verifications: Users can further augment their scores by providing additional identity or financial verifications, ensuring added layers of trustworthiness.
e. Trust Score Implications:
   i. Enhanced Processing Speed: Users with higher trust scores benefit from expedited transaction processing, acknowledging their consistent positive transactional behavior.
   ii. Fee Reductions: Trustworthy users might be eligible for reduced transaction fees or special promotions as a reward for their reliability.
   iii. Expanded Transaction Limits: Users with elevated trust scores might access higher transaction limits, reflecting their proven credibility.
f. User Interface and Feedback:
   i. Trust Dashboard: Users can access a dedicated dashboard, displaying their current trust score, influencing factors, and potential benefits they can unlock.
   ii. Score Evolution Tracking: Users can view their trust score's historical trajectory, understanding the impacts of their transactional behaviors.
g. Safety and Compliance:
   i. Dispute Resolution and Score Impact: In cases of disputes, a robust resolution mechanism evaluates the issue, potentially affecting the involved parties' trust scores based on the outcome.
   ii. Regular Audits: To maintain system integrity, random audits ensure users' trust scores genuinely reflect their transactional behaviors and credibility.
h. Reporting and Analytics:
   i. Personalized Insights: Users receive insights on how to enhance their trust scores, encouraging positive transactional practices.

i. System Analytics: Backend analysis of trust scores assists in refining the rating algorithm and understanding overall user behavior patterns.

Regional Clustering—Grouping transactions based on specific regions or corridors to expedite the matching process, especially in high-traffic areas. Specifically, to a method for streamlining and optimizing the matching process of cross-border transactions by utilizing regional-based clustering, with a focus on areas with significant transactional traffic.
a. As global cross-border transaction volumes grow, ensuring efficient and timely transaction matching becomes increasingly challenging. Traditional systems that process transactions in a linear or indiscriminate manner may face bottlenecks, especially in high-traffic corridors. A method to prioritize group transactions based on their geographical regions can alleviate this challenge.
b. The present system introduces “Regional Clustering”—a mechanism that groups transactions by specific regions or corridors. By categorizing transactions in this manner, the system can expedite the matching process, particularly beneficial in areas with high transactional volume.
c. Defining Regional Clusters:
   i. Corridor Identification: The system identifies and categorizes regions or corridors based on historical and real-time transaction data.
   ii. Dynamic Cluster Creation: Clusters are formed dynamically, considering factors like transactional volume, currency pairs, and geopolitical boundaries.
d. Transaction Categorization:
   i. Automatic Sorting: As transactions are initiated, the system automatically sorts them into their respective regional clusters based on origin and destination data.
   ii. Prioritization Logic: Within clusters, transactions can be further prioritized based on urgency, amount, or trust scores of the involved parties.
e. Optimized Matching:
   i. Cluster-Based Algorithms: Dedicated matching algorithms cater to each cluster, considering the specific characteristics and needs of that region.
   ii. Reduced Search Space: By limiting the matching process to a defined cluster, the search space is reduced, resulting in quicker transaction pairing.
f. User Interface and Interaction:
   i. Cluster Visibility: Users can view their transactions within the context of regional clusters, providing clarity on the processing status.
   ii. Feedback Mechanism: Users can provide feedback or preferences on their regional cluster assignments, refining the system's categorization over time.
g. Scalability and Flexibility:
   i. Adaptive Cluster Resizing: Based on transactional demand, clusters can be resized or redefined to maintain optimal processing efficiency.
   ii. Integration with Other Features: Regional Clustering seamlessly integrates with other system features, such as Priority Transactions or Trust Ratings, to further enhance transaction processing.
h. Reporting and Analytics:
   i. Cluster Performance Metrics: Backend analytics provide insights into each cluster's performance, identifying areas for optimization or adjustment.
i. User Insights: User interaction with regional clusters offers valuable insights into user preferences, behaviors, and potential future transaction trends.

Hedging Options—Offer users the choice to hedge their transactions against potential exchange rate fluctuations for a fee. With a specific focus on providing users with an option to protect their cross-border transactions from potential exchange rate fluctuations through a hedging mechanism, available for an associated fee.
a. In the realm of cross-border transactions, exchange rate fluctuations pose a considerable risk. This volatility can result in financial losses for users, depending on the timing and rate at the moment of transaction completion. A system allowing users to hedge their transactions would provide predictability and security against these unforeseen shifts in exchange rates.
b. The current system introduces “Hedging Options”—a feature within the cross-border payment platform that allows users to lock in a specific exchange rate for their transaction, thereby insulating it from potential rate fluctuations, in exchange for a fee.
c. Hedge Activation:
   i. User Selection: Upon initiating a transaction, users are presented with the option to hedge the exchange rate, showcasing the current rate and the associated fee for this service.
   ii. Rate Lock-In: Once the hedging option is selected, the system locks in the prevailing exchange rate for that transaction, ensuring rate consistency until completion.
d. Fee Structure:
   i. Dynamic Pricing: The hedging fee might be determined dynamically based on factors such as current market volatility, transaction size, or the currencies involved.
   ii. Transparency: Users are provided a detailed breakdown of the hedging fee and its benefits before confirming their choice.
e. Duration and Limitations:
   i. Hedging Duration: The hedging protection might have a stipulated duration, ensuring the transaction completes within this window to benefit from the locked-in rate.
   ii. Extension Options: For extended protection, users might have the option to extend the hedging duration for an additional fee.
f. User Interface and Interaction:
   i. Hedging Dashboard: Users have access to a dashboard that displays their hedged transactions, the locked-in rates, durations, and associated fees.
   ii. Notifications: Real-time alerts notify users of any impending expiry of their hedge protection, prompting necessary actions.
g. Safety and Compliance:
   i. Regulatory Adherence: The hedging mechanism complies with financial regulations, ensuring user protection and system integrity.
   ii. Hedging Partnerships: The system may collaborate with financial institutions or forex platforms to ensure seamless rate lock-ins and hedging execution.
h. Reporting and Analytics:
   i. User Reports: Users can generate reports detailing their hedging history, benefits accrued, and fees paid.
   ii. System Insights: Backend analytics provide insights into user adoption of the hedging option, fee structures, and potential optimizations based on market trends.

Multi-Currency Pool—Allow users to maintain balances in multiple currencies, enhancing the flexibility and speed of matching transactions. More specifically, to a mechanism allowing users of a cross-border payment platform to maintain and manage balances in various currencies, thereby increasing transactional flexibility and matching efficiency.
a. In the realm of cross-border payments, users often transact in diverse currencies, which might necessitate repeated conversions, leading to potential losses due to fluctuating exchange rates and increased transaction times. A solution that allows users to maintain balances in multiple currencies can streamline this process, saving time and reducing associated costs.
b. The present system introduces “multi-Currency Pools”—a feature that empowers users to hold, manage, and transact using multiple currency balances within the same platform. This approach optimizes transaction matching processes and offers increased flexibility to users.
c. Account Initialization:
   i. User Selection: At the time of account setup, users can choose the preferred currencies they anticipate transacting in, establishing individual currency pools for each.
   ii. Default Currency: While users maintain multiple currencies, they can set a default currency for receiving funds or making default payments.
d. Balance Management:
   i. Deposits and Withdrawals: Users can deposit or withdraw from individual currency pools as needed.
   ii. Internal Conversions: Should the need arise, users can effortlessly convert balances between their currency pools at prevailing rates, with the platform providing real-time rates and conversion fees.
e. Transactional Flexibility:
   i. Direct Matching: When initiating or receiving a payment, the system first checks the relevant currency pool. Direct matches are prioritized, reducing the need for external currency conversions, and expediting transaction times.
   ii. Auto-Conversion: In scenarios where a direct match is not possible, the system can auto-convert from one of the user's currency pools to fulfill the transaction, based on user preferences or optimal conversion rates.
f. User Interface and Insights:
   i. Currency Dashboard: Users can access a comprehensive dashboard displaying balances across their currency pools, along with transaction histories, conversion rates, and relevant analytics.
   ii. Balance Notifications: Real-time alerts notify users if any currency balance is low or if there is an advantageous rate for conversions.
g. Integration with Other Features:
   i. Hedging Compatibility: Users can opt to hedge individual currency balances, providing added protection against rate fluctuations.
   ii. Trust Ratings and Limits: Depending on the platform's other features, multi-currency pools might have transaction limits based on user trust ratings or verifications.
h. Security and Compliance:
   i. Regulatory Oversight: The multi-currency pool mechanism adheres to international banking and finance regulations, ensuring user funds' safety and system integrity.
   ii. Auditing and Reporting: For transparency, the system facilitates periodic audits and provides users with detailed financial statements.

Notifications—Real-time notifications about favorable exchange rates or ideal times to make a transfer based on predictive Al based analytics. Specifically, to a method for notifying users in real-time about advantageous exchange rates or optimal moments to initiate transfers, utilizing predictive analytics powered by artificial intelligence.
a. With exchange rates undergoing constant fluctuations, users engaged in cross-border transactions often face unpredictability. An intelligent system that proactively alerts users about favorable conditions based on predictive analytics could ensure users benefit from the best possible rates and timings.
b. The present system introduces “Notifications”—a feature that leverages artificial intelligence (AI) to analyze historical and real-time data to predict future exchange rate movements. Users receive real-time notifications about ideal rates or optimal times to transact, thereby maximizing their financial outcomes.
c. Data Aggregation and Analysis:
   i. Source Integration: The Al system integrates various data sources, including historical exchange rates, global financial news, market trends, and geopolitical events.
   ii. Predictive Modeling: Utilizing machine learning, the system establishes predictive models that forecast short and long-term exchange rate fluctuations.
d. User-Centric Customization:
   i. Profile Analysis: The system evaluates each user's transaction history, preferences, and frequency to customize notification thresholds and timings.
   ii. Adaptive Learning: As users react to or ignore notifications, the AI adjusts its predictive models and notification parameters to align better with individual user behavior.
e. Notification Delivery:
   i. Real-Time Alerts: When the system identifies a favorable rate or an optimal transaction window based on its predictions, users receive immediate notifications through their preferred communication channels.
   ii. Contextual Information: Notifications provide context, explaining why a particular moment is deemed optimal or what factors are influencing the predicted rate.
f. User Interaction and Feedback:
   i. Interactive Dashboard: Users can access a dashboard showing predictive analyses, potential rate trajectories, and past notification histories.
   ii. Feedback Loop: Users can provide feedback on the accuracy and utility of notifications, refining the Al's predictive capabilities over time.
g. Security and Compliance:
   i. Data Protection: All data, including user profiles and transaction histories, are encrypted and protected, adhering to global data privacy regulations.
   ii. Transparency: Users are informed about the data sources the AI system uses and have the option to opt-out of specific data integrations.
h. Integration with Other Features:
   i. Transactional Synergy: Notifications can integrate with features like Multi-Currency Pools or Hedging Options, offering users a holistic transaction optimization experience.
   ii. Historical Insights: Users can view historical predictions and their outcomes, fostering trust in the system's predictive capabilities.

Integration with Digital Wallets and Cryptocurrencies—As a future-proofing measure, allow transactions to be matched and converted involving digital currencies, making use of blockchain's transparent and immutable ledger properties.
a. The rising adoption of digital currencies and blockchain technology has reshaped global financial transactions. Integrating these advancements into cross-border payment systems offers enhanced security, transparency, and inclusivity, accommodating users who transact in cryptocurrencies.
b. The present system introduces a feature that facilitates integration with digital wallets and cryptocurrencies, enabling users to match and convert cross-border transactions using digital currencies. The system harnesses blockchain's inherent properties to ensure secure, transparent, and efficient transactions.
c. Digital Wallet Synchronization:
   i. Wallet Linking: Users can securely link their digital wallets, facilitating seamless cross-border transactions using their cryptocurrency balances.
   ii. Multi-Currency Support: The system supports a diverse range of digital currencies, allowing users flexibility in transaction choices.
d. Blockchain-Based Matching and Conversion:
   i. Distributed Ledger Verification: Upon transaction initiation, the system leverages blockchain's distributed ledgers for verification, ensuring data integrity.
   ii. Smart Contracts: Employ smart contracts to automate and enforce transaction conditions, guaranteeing that transactions are executed as agreed upon by parties.
e. Rate Determination and Transparency:
   i. Real-time Rate Monitoring: The system continuously monitors global exchange rates for digital currencies, ensuring users receive the most favorable rates during matching and conversion.
   ii. Immutable Receipts: Post-transaction, users receive blockchain-based receipts, ensuring complete transparency and tamper-proof transaction records.
f. Security Measures:
   i. Encryption Standards: All digital currency transactions are encrypted using cryptographic standards, safeguarding user funds and data.
   ii. Decentralized Validation: Transactions undergo decentralized validation, harnessing the collective verification power of the blockchain network.
g. User Experience and Interface:
   i. Unified Dashboard: Users can monitor their traditional and digital currency balances, view transaction histories, and access blockchain-based receipts from a unified interface.
   ii. Notifications: Real-time alerts keep users informed about transaction statuses, digital currency rate changes, and any required user actions.
h. Compliance and Regulation Adherence:
   i. Regulatory Alignment: The system ensures that all digital currency transactions adhere to local and international cryptocurrency regulations.
   ii. Anti-Money Laundering (AML) & Know Your Customer (KYC): Implement stringent AML and KYC checks for digital currency transactions, ensuring platform integrity and user protection.

Tiered Service Levels—Different levels of service, from basic matching to premium services that might include faster transfers, better exchange rates, or first access to new features.
a. In the context of cross-border transactions, different users have different needs, from cost-effectiveness to speed, reliability, and exclusive benefits. A tiered service structure that tailors' offerings to individual needs can significantly enhance user satisfaction and system efficiency.
b. The present system introduces “Tiered Service Levels”—a feature that provides users with a variety of service levels, from basic transaction matching to premium offerings. The latter could encompass expedited transfers, superior exchange rates, and early access to new features, fostering a personalized and optimized user experience.
c. Service Levels:
i. Basic Level: Offers users the standard transaction matching service with regular processing times, standard exchange rates, and access to the platform's fundamental features.
ii. Premium Levels: These are higher tiers offering a variety of exclusive benefits such as expedited transfers, preferential exchange rates, priority transaction matching, and early access to newly introduced platform features.
d. User Selection and Transition:
i. Flexible Transitioning: Users can upgrade, downgrade, or change their service level based on their evolving needs and preferences.
ii. Trial Offers: New or prospective users could be offered trial periods for premium levels to experience the enhanced benefits firsthand.
e. Pricing and Payment:
i. Transparent Pricing: Each service level comes with transparent pricing or fees, clearly communicating what users receive for their chosen level.
ii. Flexible Payment: Options for payment can include traditional methods or through platform-earned rewards or credits.
f. User Interface:
i. Service Level Dashboard: A user-friendly dashboard allows users to easily navigate and understand the benefits and costs associated with each service level.
ii. Usage Analytics: Users have access to analytics showcasing their usage patterns, savings, and benefits realized at their current service level, aiding informed decisions about potential transitions.
g. Integration with Other Features:
i. Trust Ratings and Limits: Depending on the platform's other features, tiered service levels might integrate with trust ratings or transaction limits, offering higher limits or ratings for premium service levels.
ii. Custom Notifications: notifications can be tailored based on service levels, offering premium users more detailed or early alerts.

Gamification and Rewards—Users earn points or rewards for frequent use, successful referrals, or even waiting longer times for matches (which can assist in balancing the system).
a. In the digital age, user engagement and loyalty can be significantly enhanced through gamified experiences. In the context of cross-border transactions, gamifying user behavior not only increases user interaction but can also optimize the system's operation.
b. The present system introduces “Gamification and Rewards”—a feature that rewards users with points or tangible benefits for actions like regular use of the platform, referring new users, or opting for extended wait times for transaction matches. This mechanism promotes system balance while fostering increased user engagement.
c. Points Accumulation:
   i. Transactional Points: Users accumulate points for every transaction they perform. The point value could vary based on transaction size or frequency.
   ii. Referral Points: Points are awarded for successfully referring new users to the platform. Bonus points might be given if the referred user performs a set number of transactions within the stipulated period.
   iii. Patience Points: Users choosing to wait longer for transaction matches, assisting in system equilibrium, earn extra points as a token of appreciation for their patience.
d. Reward Redemption:
   i. Direct Benefits: Accumulated points can be converted into direct benefits like discounted transaction fees, better exchange rates, or cashback.
   ii. Tiered Advantages: Upon reaching specific point milestones, users could unlock higher service tiers, gaining access to premium platform features.
e. User Engagement Features:
   i. Leaderboards: Display top users based on accumulated points, fostering a sense of competition and achievement.
   ii. Achievement Badges: Award visual badges for milestones like “Top Referrer” or “Most Patient User” to acknowledge and celebrate user contributions.
f. Feedback and User Interaction:
   i. Reward History: Users can view their points' earning and redemption history, ensuring transparency.
   ii. Interactive Tutorials: Offer guided tutorials or challenges, educating users about the platform and potentially rewarding completion.
g. Integration with System Operations:
   i. System Balance Incentives: By rewarding users for behaviors that assist in system balance, the platform can strategically manage high-traffic periods or currency imbalances.
   ii. Promotional Campaigns: Periodically introduce campaigns where users can earn double points or exclusive rewards to spur platform engagement and activity.

Smart Contracts Integration—Use smart contracts to automatically execute the conditions of a transaction, making it transparent and tamper-proof.
a. As the digital realm advances, trust and transparency become paramount in financial transactions. Smart contracts, powered by blockchain technology, ensure that contractual conditions are executed automatically and transparently, without the need for intermediaries, reducing the risk of fraud and disputes.
b. The present system integrates “Smart Contracts” into a cross-border payment system. These self-executing contracts have the terms of the agreement written into code. They ensure that conditions and actions relating to a transaction are met and executed transparently, reliably, and tamper-proof.
c. Contract Creation:
   i. User-defined Conditions: Parties involved can set specific conditions for a transaction, such as the agreed exchange rate, transaction fees, or timing.
   ii. Template Selection: Users can choose from predefined contract templates suitable for standard transaction types, ensuring ease of use.
d. Execution Mechanism:
   i. Automatic Validation: Once conditions are met, the smart contract automatically validates and executes the transaction without manual intervention.
   ii. Blockchain Confirmation: Post-execution, the transaction is recorded on the blockchain, ensuring it is immutable and traceable.
e. Transparency and Security:
   i. Public Ledger: Transactions executed via smart contracts are recorded on a public ledger, ensuring transparency, and allowing users to verify transaction details.
   ii. Cryptography: Smart contracts leverage cryptographic techniques, ensuring that contract terms remain secure and tamper-proof.
f. Dispute Resolution:
   i. Built-in Arbitration: In case of discrepancies or disputes, the smart contract can be designed to pause and redirect the transaction for arbitration, ensuring fairness.
   ii. Historical Access: All contract iterations and transaction details are stored, providing a comprehensive history that can aid in dispute resolution.
g. Integration with System Features:
   i. Tiered Services: Premium or higher-tier users might be offered smart contract features or templates, enhancing their transaction experience.
   ii. Notifications: Users are alerted in real-time about the status of their smart contract—weather conditions are met, if there are any discrepancies, or upon successful execution.

Security Enhancements—Multi-factor authentication, biometric verifications, or blockchain-based security for added layers of protection.
a. As cyber threats evolve, ensuring the security of digital financial transactions becomes ever more paramount. Integrating authentication and verification methodologies is crucial in safeguarding users' funds and personal information within cross-border payment systems.
b. Multi-factor Authentication (MFA):
   i. Layered Verification: Beyond the basic username and password, users are required to provide at least one additional verification factor, which could be something they know (PIN, answer to a security question), something they have (a security token or code sent via SMS), or something they are (biometric).
   ii. Dynamic Codes: Generate one-time codes sent to users' registered devices or email, ensuring that even if primary credentials are compromised, unauthorized access is restricted.
c. Biometric Verifications:
   i. Fingerprint Scanning: Allow users to authenticate using fingerprint scans, leveraging identity and access patterns to grant access.
   ii. Facial Recognition: Using algorithms, the system can scan and match users' facial patterns against stored data.
   iii. Voice Recognition: The system can be trained to recognize a user's voice pattern, adding another layer of biometric security.
d. Blockchain-Based Security:
   i. Immutable Ledgers: Transaction records are stored in a manner that makes them tamper-evident, ensuring any unauthorized changes can be quickly detected.
   ii. Decentralized Storage: Data is stored across a network of computers, making a single point of failure or breach nearly impossible.
   iii. Cryptography: Transaction details and user data are encrypted using cryptographic techniques, ensuring data remains confidential and secure.
e. User Interaction and Experience:
   i. Customizable Settings: Users can customize their security settings, choosing which methods they prefer or deem necessary based on their risk perception.
   ii. Security Alerts: Real-time notifications alert users of any suspicious activity, and they can take immediate action, like freezing their account or changing passwords.
f. Integration with System Operations:
   i. Continuous Monitoring: Continuously monitor for abnormal patterns or suspicious activities, prompting immediate security checks when anomalies are detected.
   ii. Periodic Updates: Regular system updates ensure that the security protocols are always ahead of emerging threats and vulnerabilities.

Machine Learning Integration—Over time, the system can learn user habits and offer predictive matching or even auto-matching based on previous behaviors.
a. With the digitization of financial transactions, the demand for intuitive and personalized user experiences is increasing. Machine learning offers the potential to understand individual user behaviors, enabling systems to make predictive decisions that enhance user experience and streamline transaction processes.
b. The present system incorporates “Machine Learning Integration” into a cross-border payment system. This feature enables the system to learn from user transactional habits over time and make predictive matching suggestions, or even autonomously match transactions, based on this learned behavior.
c. Data Collection:
   i. Behavioral Tracking: The system continuously logs user transactional behaviors, including preferences for transaction times, amounts, destinations, and matching priorities.
   ii. Feedback Loop: Users can provide feedback on the system's suggestions, further refining the ML model.
d. Predictive Matching:
   i. Recommendation Engine: Leveraging ML algorithms, the system suggests potential transaction matches based on user's historical behaviors and preferences.
   ii. Dynamic Adaptation: The system adapts its suggestions in real-time based on recent transactions and user feedback.
e. Auto-Matching:
   i. User Opt-In: Users have the choice to enable auto-matching, where the system autonomously matches their transactions based on prior behaviors.
   ii. Safety Parameters: Limits can be set by the user (e.g., maximum transaction amount or specific corridors) to ensure the auto-matching remains within their comfort zone.
f. User Interaction and Experience:
   i. Personalized Dashboard: Users can view their transaction habits, the system's predictions, and the accuracy rate of auto-matched transactions.
   ii. Adaptive Learning: If a user's transaction behavior changes, the system recognizes these changes and adjusts its predictive and auto-matching algorithms accordingly.
g. Integration with System Operations:
   i. Continuous Model Training: As more transaction data is accumulated, the ML model continuously refines its predictions, enhancing accuracy over time.
   ii. Scalability: The system can handle increasing volumes of transactions without compromising on the accuracy of its matching suggestions.

Collaborative Filtering—The system could suggest potential matches or even beneficial transaction times based on behaviors of users with similar profiles.
a. In the rapidly evolving digital finance landscape, there is an increasing need to provide users with intelligent and tailored recommendations to enhance their transaction experience. Collaborative filtering, a method used extensively in recommendation systems, offers a solution by analyzing the behaviors and preferences of similar users.
b. The present system integrates “Collaborative Filtering” into a cross-border payment system. This feature enables the system to assess transactional behaviors across a multitude of users, identify those with similar profiles, and subsequently recommend potential transaction matches or favorable transaction times derived from these analogous behaviors.
c. User Profiling:
   i. Behavioral Metrics: The system continually tracks user metrics, such as preferred transaction amounts, frequency, corridors, and preferred matching criteria.
   ii. Profile Clustering: Users are grouped based on their transaction behaviors, creating clusters of users with analogous profiles.
d. Recommendation Engine:
   i. Match Suggestions: For a given user, the system analyzes transactions made by users in the same cluster and suggests potential matches that align with the preferences of that cluster.
   ii. Optimal Transaction Times: By analyzing the transaction times of similar users, the system can suggest times when the user might find favorable rates or quicker matches.
e. Feedback Loop:
   i. User Feedback: Users can provide feedback on the recommendations, allowing the system to refine its collaborative filtering algorithms.
   ii. Model Retuning: Based on feedback and evolving user behaviors, the model undergoes periodic adjustments to enhance recommendation accuracy.
f. User Interaction and Experience:
   i. Tailored Recommendations: Users receive suggestions that are not just based on their own transaction history but also the behaviors of users with similar profiles, leading to more accurate and relevant recommendations.
   ii. Interactive Dashboard: Users can explore the behaviors of their cluster, see the basis for recommendations, and adjust their preferences if needed.
   g. Integration with System Operations:
   i. Dynamic Clustering: As more users join and as transactional behaviors evolve, the system dynamically adjusts its clusters.
   ii. Real-time Analysis: The system performs real-time data analysis to provide users with the most current and relevant recommendations.

### Environmental Impact Metrics

a. Calculate and display the reduced environmental impact (such as reduced paperwork, server processing time) of using the domestic matching system over traditional cross-border transactions.
b. Amidst growing global environmental concerns, consumers and businesses alike are seeking eco-friendly alternatives in their daily operations. Digitalizing transactions can potentially reduce the environmental footprint associated with financial processes, and there is a need for tangible metrics to showcase these benefits.
c. The present system introduces “Environmental Impact Metrics” to a domestic matching system for cross-border payments. This feature calculates and showcases the environmental benefits, such as reductions in paper usage or server processing time, achieved by using the domestic matching system as opposed to traditional cross-border transaction methods.
d. Data Collection:
   i. Traditional Metrics: Data points related to the environmental impact of conventional cross-border transactions are collected, including paper usage, energy consumption for processing, transportation impacts, and more.
   ii. Domestic Matching Metrics: Environmental data points related to the domestic matching system are similarly collected.
e. Impact Calculation Engine:
   i. Comparison Analysis: The system compares traditional metrics with domestic matching metrics to determine the environmental savings achieved.
   ii. Dynamic Update: As usage patterns change and as environmental data evolves, the system updates the environmental impact metrics in real-time.
f. Display and User Interface:
   i. Interactive Dashboard: Users can view a detailed breakdown of environmental savings, categorized by factors like paper reduction, energy savings, etc.
   ii. Visual Representation: Graphs, charts, and infographics dynamically showcase the comparative environmental benefits to users.
g. User Engagement and Education:
   i. Eco-tips: Based on metrics, the system can offer tips to users on how to further reduce their environmental footprint in other areas of financial operations.
   ii. Achievement Badges: Users who consistently use the domestic matching system can be awarded badges or recognition for their contribution to environmental conservation.
h. Integration with System Operations:
   i. Continuous Monitoring: The system constantly monitors both traditional and domestic matching operations to gather real-time data.
   ii. Periodic Auditing: External or internal environmental audits can be conducted to validate and enhance the accuracy of the metrics displayed.

Advantages and Innovations—The present system offers several advantages and innovations, including but not limited to:
a. Cost Savings: By eliminating the need for international transactions, the system reduces transaction fees, foreign exchange charges, and other associated costs.
b. Real-time (near-real time) transfers drastically reduce delays in processing transactions and settling fund compared to current processing time which takes 24 to 72 hours for international money transfers. Enabling real-time or near real-time transactions, our system drastically reduces the processing time compared to the standard 24 to 72 hours for cross-border payments, enhancing efficiency in global financial interactions.
c. Independent from legacy payment networks: The system stands out independent from legacy payment networks, eliminating reliance on conventional banking channels like SWIFT and SEPA. This independence streamlines operations, minimizing complexities and contributing to a more efficient and adaptable financial ecosystem.
d. Enhanced Efficiency: The direct domestic transfers minimize processing delays, settlement times, and reliance on multiple intermediaries.
e. Simplified Money Movement Processes: Cross-border complexities, including compliance requirements, currency conversions, and regulatory hurdles, are alleviated.
f. Improved User Experience: Users benefit from a seamless and transparent fund transfer experience, resulting in enhanced customer satisfaction.
g. Scalability: The system can accommodate a large volume of transactions across multiple countries, facilitating global payment flows.
h. As a first aspect, the payment system for facilitating direct fund transfers between different countries by identifying matching transactions and converting them into separate domestic transfers within each respective country.
i. As a second aspect based on the first aspect, the identification of matching transactions is based on generating a money movement bids (demands) and fulfilling (accepting) a bid mechanism.
j. As a third aspect based on the first aspect, the conversion of transactions into domestic transfers is performed by deducting funds from the sender's p2pHub account in their respective country and depositing them into the recipient's p2pHub account in the same country.

### DETAILED DESCRIPTION OF FIGURES

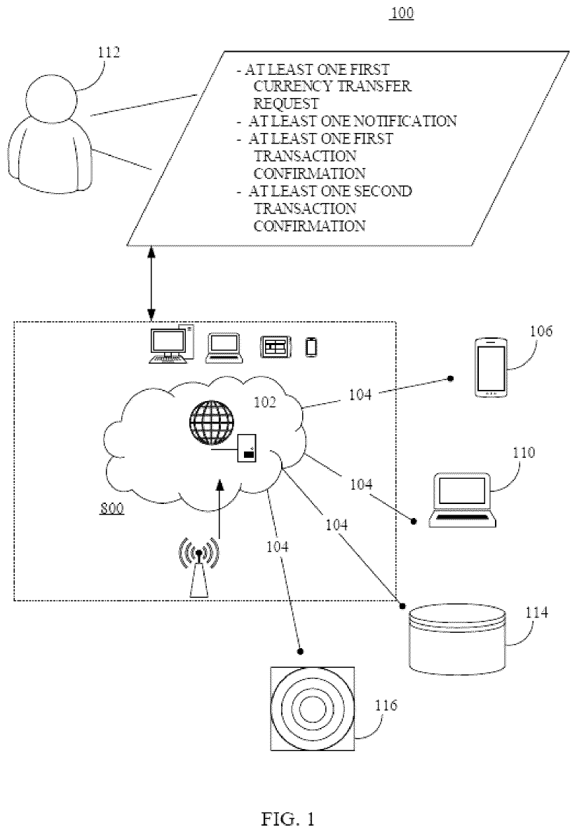

1. Referring now to FIG. 1, the illustration depicts an online platform 100 for facilitating cross-border financial transactions by matching transaction requests and converting them into domestic equivalents. The online platform 100 is hosted on a centralized server 102, which communicates with various entities via a communication network 104. These entities include user devices 106 (such as smartphones, tablets, or laptops), other electronic devices 110 (such as desktop computers or servers), and databases 114 that store transaction data and regulatory compliance information. Users 112, including end-users and administrators, access the platform through web-based or mobile applications on these devices. The platform enables secure data exchange and transaction processing while ensuring adherence to Anti-Money Laundering (AML) and Know Your Customer (KYC) regulations. Components such as sensors 116 are used only if required for additional data acquisition or monitoring.

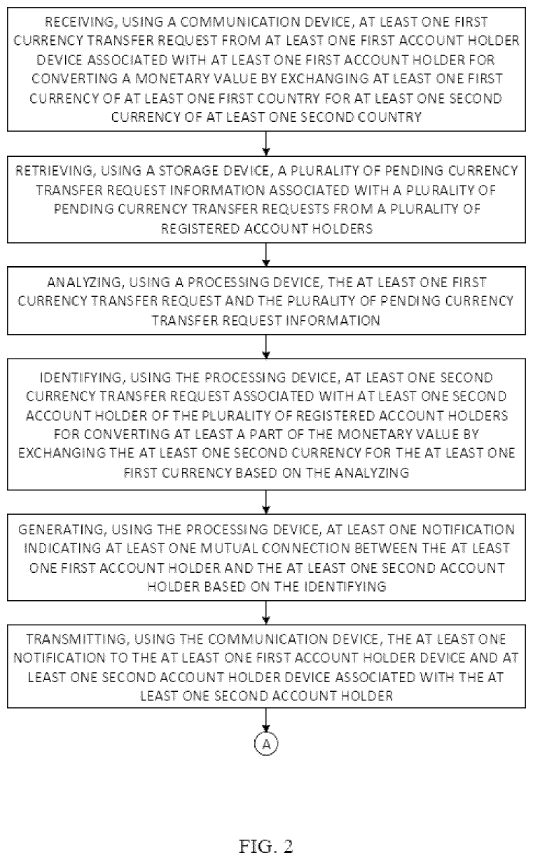

2. FIG. 2 is a flowchart illustrating a method for facilitating cross-border payments with matching transaction conversion into domestic transactions, in accordance with some embodiments of the present disclosure. The method includes the following steps:
Receiving Transaction Requests: Receiving, using a communication device, at least one first currency transfer request from at least one first account holder device associated with at least one first account holder, the request specifying a monetary value for converting at least one first currency of at least one first country into at least one second currency of at least one second country. The at least one first account holder device may include, but is not limited to, a smartphone, laptop, desktop, or tablet computer.
Retrieving Pending Request Data: Retrieving, using a storage device, a plurality of pending currency transfer requests associated with a plurality of registered account holders.
Analyzing Data: Analyzing, using a processing device, the at least one first currency transfer request and the plurality of pending currency transfer requests to identify potential matches.
Identifying Complementary Transactions: Identifying, using the processing device, at least one second currency transfer request associated with at least one second account holder of the plurality of registered account holders for converting a monetary value by exchanging the at least one second currency for the at least one first currency, based on the analysis.
Generating Notifications: Generating, using the processing device, at least one notification indicating at least one match between the at least one first account holder and the at least one second account holder.
Transmitting Notifications: Transmitting, using the communication device, the at least one notification to the devices of the at least one first account holder and the at least one second account holder.

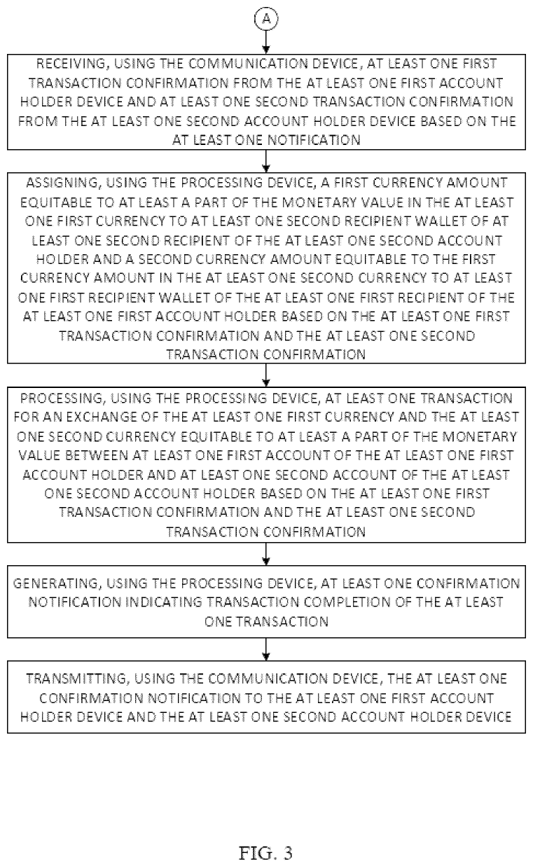

3. FIG. 3 is a continuation of the flowchart described in FIG. 2, illustrating additional steps for processing matched transactions and completing cross-border payment operations. The steps include:
Receiving Transaction Confirmations: Receiving, using the communication device, at least one transaction confirmation from the at least one first account holder device and the at least one second account holder device based on the notification.
Assigning Currency Amounts: Assigning, using the processing device, a first currency amount equivalent to at least a portion of the monetary value in the at least one first currency to at least one second recipient wallet associated with the at least one second account holder, and assigning a second currency amount equivalent to the first currency amount in the at least one second currency to at least one first recipient wallet associated with the at least one first account holder.
Processing Domestic Transfers: Processing, using the processing device, at least one domestic fund transfer between the system and a bank through banking Software System's Interfaces (e.g., APIs) or agent services to transfer the assigned monetary value to bank accounts associated with the recipients in their respective countries.
Generating Completion Notifications: Generating, using the processing device, at least one confirmation notification indicating successful completion of the transaction.
Transmitting Completion Notifications: Transmitting, using the communication device, the confirmation notification to the devices of the first and second account holders.

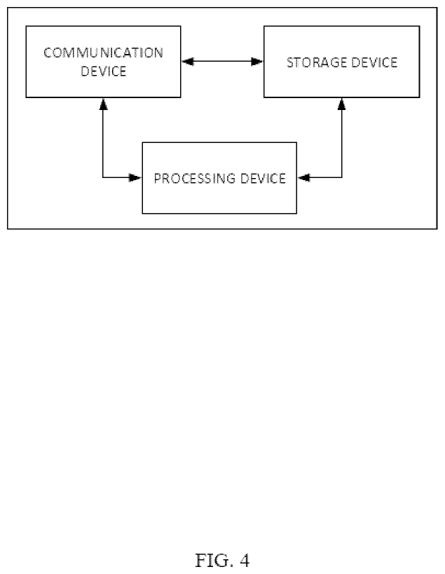

4. FIG. 4 illustrates a block diagram of a system for facilitating cross-border payments with matching transaction conversion into domestic transactions, in accordance with some embodiments. The system includes the following components:

### Communication Device:

Configured to receive currency transfer requests from account holder devices, such as smartphones, laptops, desktops, or tablets, associated with senders and recipients.
Transmits notifications regarding transaction matches and confirmations to account holder devices.
Receives transaction confirmations from account holder devices to proceed with processing and settlement.
Sends final confirmation notifications to all parties upon successful transaction completion.

### Processing Device:

Analyzes received transfer requests alongside pending transaction data to identify complementary matches based on predefined criteria, such as currency, amount, and timing.
Generates notifications for identified matches, linking the corresponding account holders.
Assigns equivalent currency amounts to recipient wallets and processes domestic transfers between accounts using bank Software System's Interfaces (e.g., APIs) or other transfer mechanisms.
Generates final confirmation notifications upon completion of transactions.

### Storage Device:

Stores pending transaction requests submitted by registered account holders.
Retrieves stored data for processing and analysis by the system.

The components are communicatively coupled, enabling seamless integration and real-time operation. The communication device interacts with the processing and storage devices to ensure secure data handling and compliance with regulatory standards.

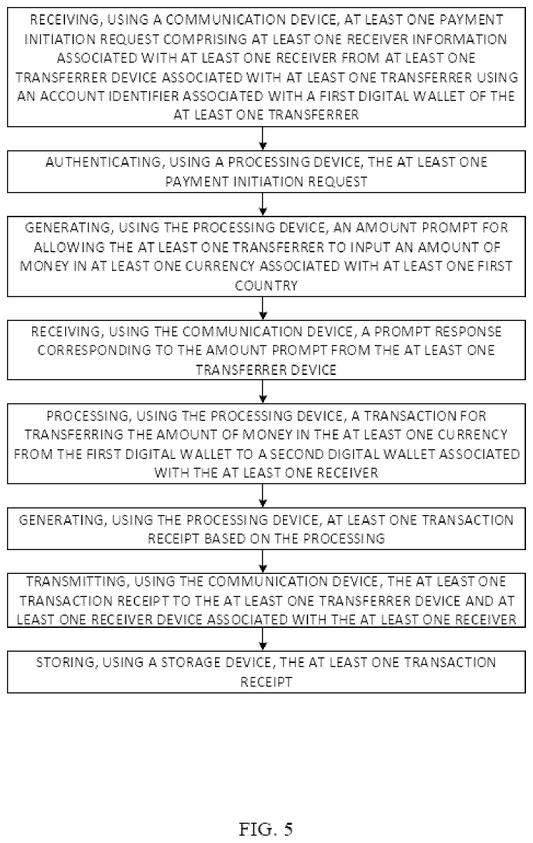

FIG. 5 illustrates a flowchart of a method for facilitating cross-border payments with matching transaction conversion into domestic transactions, in accordance with embodiments of the present disclosure. The method comprises the following steps:
Receiving Payment Initiation Requests: Receiving, using a communication device, at least one payment initiation request comprising at least one receiver information associated with at least one receiver from at least one transferrer device, the request identifying a digital wallet or account identifier of the transferrer. The transferrer device may include, but is not limited to, a smartphone, laptop, desktop, tablet, or any electronic device capable of transmitting the request.
Authenticating Payment Initiation Requests: Authenticating, using a processing device, the at least one payment initiation request by verifying transferrer identity and validity of the digital wallet or account, employing one or more mechanisms such as multi-factor authentication, encryption protocols, or other identity verification techniques.
Generating an Amount Prompt: Generating, using the processing device, a prompt requesting the transferrer to input a desired transaction amount, the amount being specified in a currency associated with the transferrer's jurisdiction or a preselected currency of operation.
Receiving the Prompt Response: Receiving, using the communication device, a response to the generated prompt, the response specifying the transaction amount and optionally including additional transaction parameters such as urgency, priority, or optional service preferences.
Processing the Transaction: Processing, using the processing device, a financial transaction to transfer the specified amount from the digital wallet or account associated with the transferrer to a second digital wallet or account associated with the receiver, wherein the transaction includes converting the transferred amount from a first currency into a second currency corresponding to the receiver's jurisdiction or preselected preferences.
Generating a Transaction Receipt: Generating, using the processing device, at least one transaction receipt documenting the details of the financial transaction, including but not limited to the transferrer's identifier, the receiver's identifier, the transaction amount, the currencies involved, the exchange rate applied, and any fees or surcharges.
Transmitting the Transaction Receipt: Transmitting, using the communication device, the transaction receipt to the transferrer's device and the receiver's device, where the receiver's device may include, but is not limited to, a smartphone, laptop, desktop, tablet, or any electronic device capable of receiving and displaying the receipt.
Storing the Transaction Receipt: Storing, using a storage device, the transaction receipt in a secure repository, ensuring compliance with regulatory requirements, enabling auditability, and supporting future retrieval for dispute resolution, reconciliation, or system analytics.

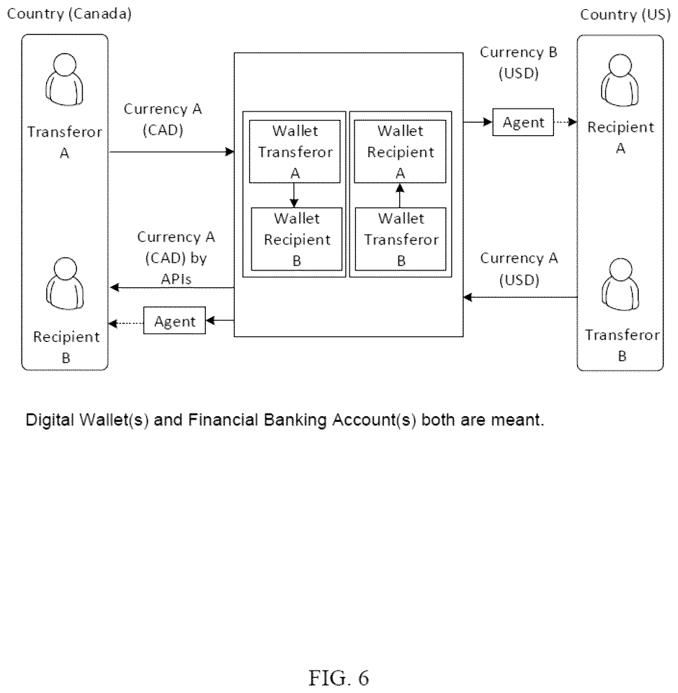

FIG. 6 illustrates a flow diagram of a system facilitating cross-border payments by matching and converting transactions into domestic equivalents, in accordance with embodiments of the present disclosure. The system is configured to enable at least one financial transaction between a transferor in a first country and a recipient in a second country, utilizing the following components:
Digital Wallets and Financial Accounts: The system includes wallets for transferors and recipients in respective countries, wherein each wallet is linked to its corresponding local currency. These wallets may be extended to represent various financial accounts, including deposit accounts, investment accounts, loan accounts, credit card accounts, or lines of credit. For instance:
   A transferor's wallet or financial account in the first country (e.g., Canada) may hold Canadian dollars (CAD), while a recipient's wallet or financial account in the second country (e.g., United States) may hold US dollars (USD).
   The system enables transactions across different account types, providing users with flexibility in managing financial assets during cross-border transactions.
Agents and Software System's Interfaces (e.g., APIs): The system leverages agents and Software System's Interfaces (e.g., APIs) to facilitate the secure conversion and transfer of monetary values between wallets and financial accounts.
   Agents: Act as intermediaries to execute domestic transactions securely within respective jurisdictions. These may include payment service providers, financial intermediaries, or third-party agents authorized to handle fund transfers.
   Software System's Interfaces (e.g., APIs): Connect to external banking systems, payment gateways, or financial services to perform real-time currency exchanges, ensuring accurate and efficient transaction processing. Software System's Interfaces (e.g., APIs) also enable seamless integration with partner institutions for compliance and transaction monitoring
Cross-Currency Transactions: The system dynamically matches cross-border transactions to enable localized processing, eliminating the need for direct international fund transfers. The process involves the following steps:
   Initiation of Transaction: A first user (transferor) in a first country initiates a transaction, specifying a monetary amount in a first currency (e.g., CAD) to be transferred to a second user (recipient) in a second country.
   Dynamic Conversion and Matching: The system identifies a complementary transaction involving a second user (transferor) in the second country intending to transfer a monetary amount in the second currency (e.g., USD). This matching ensures that cross-border requirements are localized.
Localized Fund Transfers:
   The system processes the transfer by converting the monetary amount in the first currency into the second currency.
   In the first country, the transferor's wallet or financial account (e.g., CAD) is debited, and an equivalent amount in the second currency (e.g., USD) is credited to the recipient's financial account or wallet through a domestic fund transfer in the second country.
End-to-End Transparency:
   The recipient receives the transferred amount in their preferred currency without direct cross-border fund movement, reducing transfer costs and transaction complexities.

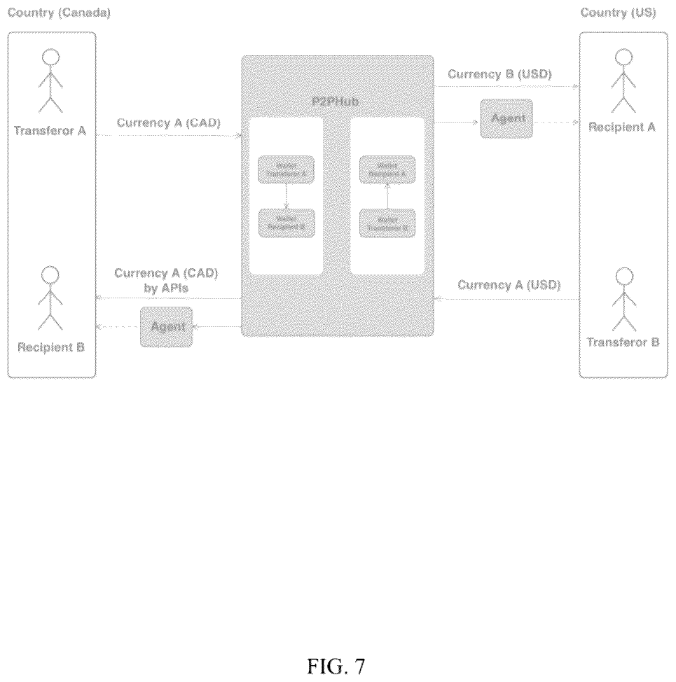

FIG. 7 is a flow diagram of a system facilitating cross-border payments with matching transaction conversion into domestic transactions, in accordance with some embodiments.

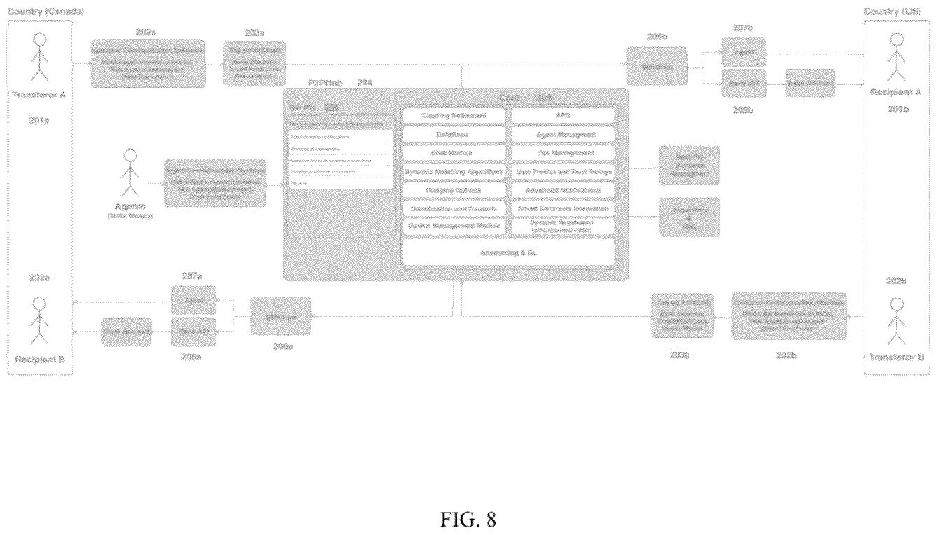

FIG. 8 is a conceptual diagram illustrating a method for facilitating cross-border payments through matching transaction conversion into domestic transactions, in accordance with embodiments of the present disclosure. The process includes the following steps:
User Registration and Identity Verification:
   A transferor (201a) from a first country (Country A) registers on the platform (202a) through customer communication channels such as a mobile app, web application, or another interface.
   The platform performs identity verification to confirm the legitimacy of the transferor (201a), ensuring compliance with Know Your Customer (KYC) protocols.
Funding the System Account: The transferor (201a) proceeds to fund their system account (203a) using multiple payment methods, including bank transfers, credit/debit card transactions, or mobile wallet top-ups. The system integrates with external financial systems via APIs or other software interfaces to facilitate secure, real-time funding.
Access to the Payment Network: Once verified and funded, the transferor (201a) gains access to the platform's payment network (204). This enables the user to initiate transactions and match their transfer requests with suitable counterparts.
Transaction Initiation and Bidding:
   The transferor (201a) begins the transaction process by specifying the transfer amount and selecting a recipient (201b) in a second country (Country B). The recipient can be chosen from a pre-established contact list or by manually entering the recipient's details.
   Before initiating a transaction, the transferor (201a) tops up their account using the system's interface (203a). This can be done through various methods, including bank transfers, credit/debit card payments, or mobile wallet top-ups. The funds are credited to the transferor's (201a) account within the system (205 and 209).
   The transferor (201a) then proceeds to either add a bid for a new transaction or select an existing bid from the marketplace. This marketplace displays reverse transfer requests originating from counterpart transferors (202b) in the second country (Country B).
   Similarly, counterpart transferors (202b) in Country B can top up their accounts through the system interface (203b), enabling them to either add their own bid or select a suitable bid for reverse transactions, aligning with their transfer needs. The funds are credited to the transferor's (202b) account within the system (205 and 209).
Dynamic Transaction Matching:
   Dynamic Transaction Matching and Marketplace Functionality: The platform operates as a money movement transaction marketplace, connecting users directly to negotiate and bid on transfer requests. This marketplace eliminates the need for traditional financial intermediaries, reducing transaction costs and enabling faster execution.
   Dynamic Matching Algorithms: When the transferor (201a) initiates a transaction to transfer funds from a source currency (Currency A) to a destination currency (Currency B), the system dynamically retrieves all available transfer requests in its database. These include transactions originating from Currency B to Currency A, initiated by a counterpart transferor (202b) in the second country, seeking to transfer funds in the opposite direction.
   Through the marketplace, users, including the transferor (201a), can bid on available transaction matches based on criteria such as transaction amount, currency type, and timing preferences.
   The system enables local trades by pairing users with complementary needs, effectively converting cross-border transactions into domestic transfers. For example, a transferor in Country A seeking to send funds to Country B can be matched with a transferor in Country B looking to send funds to Country A. The system uses its matching algorithm to optimize the pairing for cost efficiency and transaction speed.
   The marketplace ensures transparency and flexibility by providing a user-friendly interface (209) where users can filter, search, and evaluate the most suitable transaction matches based on their preferences, including exchange rates and transaction timing.
   By facilitating this peer-to-peer matching process, the system enables seamless cross-border financial transactions without the need for conventional bank or remittance intermediaries.
Refined Filtering and Selection: A refined list of matching transactions is presented to the transferors (201a or 202b) through an intuitive interface (205 & 209), allowing systematic filtering and selection of a reverse transaction that best meets their needs.
Execution of Matched Transactions: Upon selecting a match, the system triggers the transaction process:
   After initiating the process, the transferor (201a) selects a matched transaction from the list displayed by the system (205 & 209). This list consists of opposite transfer requests originating from another user (202b) in the second country (Country B) seeking to transfer funds to a user (202a) in the first country (Country A). The selection ensures alignment between the transferor's (201a) intention to send funds to a recipient (201b) in the second country (Country B).
   The system (205 and 209) facilitates the money movement by managing the transactions as localized domestic transfers:
      In Country A: A domestic transfer is executed from the transferor (201a) to the counterpart (202a) using the source currency (Currency A, e.g., CAD). The transfer is completed using local banking systems (208a), payment processors, or agents (207a) connected via APIs or software interfaces.
      In Country B: Simultaneously, a domestic transfer is initiated in the second country from the counterpart (202b) to the recipient (201b) using the destination currency (Currency B, e.g., USD). The system ensures secure execution of the transfer through local domestic channels). The transfer is completed using local banking systems (208b), payment processors, or agents (207b) connected via APIs or software interfaces.
Domestic Fund Withdrawal:
   In Country A, the recipient (202a) withdraws the transferred funds using the system's withdrawal interface (206a), which connects to domestic payment networks. These networks facilitate secure fund transfers from the system to the recipient's financial account or wallet.
   The payment networks utilized may include, but are not limited to:
      Agents (207a): Authorized intermediaries who facilitate domestic transactions.
      Bank APIs (208a): Secure application programming interfaces used for direct integration with local financial institutions.
      Domestic Payment Networks: Examples from Canada include SWIFT, Automated Funds Transfer (AFT), INTERAC, credit card payouts, and direct bank debit mechanisms. These examples are illustrative and not limiting to the system's global applicability.
   Similarly, in Country B, the recipient (201b) withdraws the transferred funds using the system's withdrawal interface (206b), connected to local domestic payment networks. The process mirrors that of Country A, utilizing:
      Agents (207b): Local intermediaries for domestic fund transfers.
      Bank APIs (208b): Secure APIs enabling direct integration with financial systems in Country B.
      Domestic Payment Networks: Examples could include ACH, Zelle, or other payment infrastructures applicable in the recipient's local region.
   The specified amount is transferred from the system's withdrawal mechanism (206b) to the recipient's (201b) financial account via domestic payment networks (207b and 208b), ensuring secure and compliant fund transfers.
Regulatory Compliance and Fraud Prevention:
   Throughout the process, the platform enforces compliance with financial regulations such as Anti-Money Laundering (AML) and KYC requirements.
   Fraud detection algorithms monitor transaction patterns, while encryption and secure communication channels protect user data.

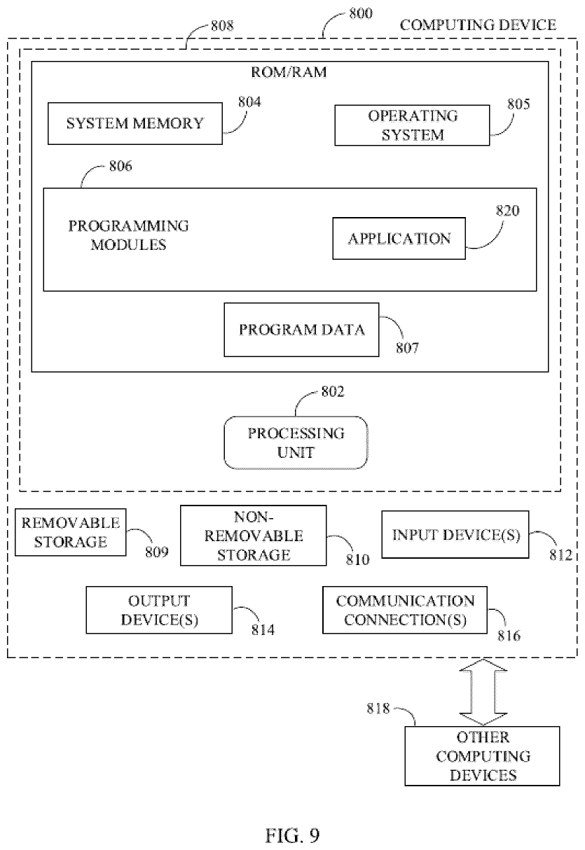

FIG. 9 illustrates a high-level computing architecture for implementing the system that facilitates cross-border financial transactions through a marketplace for matching and converting transactions into domestic equivalents. This infrastructure underpins the core functionalities of the platform, including dynamic transaction matching, compliance enforcement, and secure fund movement.
Processing Unit (802):
   Executes the platform's core algorithms, including:
      Matching Engine: Identifies complementary transaction requests by applying predefined parameters (e.g., transaction amount, currency type, and geographical region) and dynamic criteria determined by machine learning algorithms.
      Transaction Optimization Module: Computes real-time exchange rates and prioritizes transactions based on user preferences and system load.
      Compliance Framework: Enforces anti-money laundering (AML) and know-your-customer (KYC) protocols by analyzing transaction and user data.
System Memory (804):
   Stores critical program modules (806) and operational data (807), including:
      User Profiles: Data about transferors, recipients, and their transaction preferences.
      Transaction History: Logs of previous transactions for compliance audits and user reference.
      Matching Algorithms: Machine learning models that refine the matching process over time.
Communication Connection (816):
   Enables seamless communication between system components and external entities, such as:
      Financial Institutions: Through APIs for domestic fund transfers and currency conversions.
      Users (201a, 202a, 201b, 202b): Ensures secure transmission of transaction requests, confirmations, and notifications.
      Regulatory Bodies: Shares audit data when required for compliance purposes.
Storage Devices (809, 810):
   Removable Storage (809): Temporarily stores encrypted backups of transaction data for disaster recovery.
   Non-Removable Storage (810): Permanently houses system-critical databases, including:
      A repository of pending transaction requests.
      Fraud detection models and security protocols.
Input Devices (812):
   Used by system administrators to configure rules for dynamic matching, compliance thresholds, and user authentication protocols.
Output Devices (814):
   Displays transaction analytics and system diagnostics to administrators. Provides real-time transaction status to users through the platform interface.
Distributed Computing Environment:

The system may leverage a distributed architecture where tasks such as transaction matching and compliance checks are performed across multiple servers. This ensures scalability for global operations

1. A system for facilitating cross-border financial transactions through a money movement transaction marketplace, comprising:
a. A matching engine, configured to:
i. Identify complementary transaction requests submitted by users in different geographical regions, wherein the transaction requests include at least transaction amount, source currency, destination currency, user-defined preferred exchange rate, and optional user preferences.
ii. Pair users with opposing transaction needs, such that a first user in a first geographical region with a request to transfer a source currency to a destination currency is matched with a second user in a second geographical region requesting a transfer in the reverse direction.
iii. Match transaction requests dynamically based on a combination of predefined parameters, including currency type, transaction amount, geographical region, and user-defined preferred exchange rate, as well as dynamically adjustable criteria derived from:
1. Real-time marketplace bidding data submitted by users, enabling users to influence transaction prioritization based on competitive bids.
2. Adaptive machine learning models trained to optimize transaction pairings for cost efficiency, timing, and compliance.
iv. Ensure transaction matching complies with regulatory requirements, including transaction monitoring for anti-money laundering (AML) and fraud detection protocols, by integrating compliance-specific matching constraints.
b. A conversion module, configured to facilitate local currency exchanges for matched transactions by executing domestic fund transfers within respective jurisdictions, eliminating the need for cross-border monetary transfers.
c. A compliance framework, enforcing identity verification, fraud detection, and secure communication protocols for all transaction requests and matched pairs.
d. A user interface, enabling users to submit transaction preferences, monitor matched transaction status, define custom exchange rates, and participate in dynamic bidding for competitive exchange rates.

2. The system of claim 1, further comprising an Application Programming Interface (API) integration layer configured to connect with financial institutions and money service businesses to facilitate seamless transaction processing.

3. The method of claim 1, wherein the system supports real-time notifications to users regarding transaction status, user's account status, activity completion, and any compliance requirements.

4. The system of claim 1, further comprising a repository for securely storing transaction data to enable auditability and compliance with data protection regulations, and standard encryption of data in-store and in-transit.
